(19) United States
(12) Patent Application Publication
(10) Pub. No.: US 2017/0075390 A1
(43) Pub. Date: Mar. 16, 2017

(54) Housing of Electronic Apparatus and Method for Manufacturing the Same

(71) Applicants: Beijing Lenovo Software Ltd., Beijing (CN); Lenovo (Beijing) Co., Ltd., Beijing (CN)

(72) Inventors: Ning Hao, Beijing (CN); Detao You, Beijing (CN); Qiang Zhang, Beijing (CN); Zhifeng Yang, Beijing (CN)

(73) Assignees: Beijing Lenovo Software Ltd., Beijing (CN); Lenovo (Beijing) Co., Ltd., Beijing (CN)

(21) Appl. No.: 14/976,392

(22) Filed: Dec. 21, 2015

(30) Foreign Application Priority Data
Sep. 10, 2015 (CN) 201510574268.0

(51) Int. Cl. G06F 1/16; B29D 99/00

(52) U.S. Cl. CPC G06F 1/1656; B29D 99/006; B29K 2101/10

(57) ABSTRACT

A method for manufacturing a housing of an electronic apparatus includes forming a planar portion of the housing as a carbon fiber plate from carbon fiber material via a hot pressing process; during the hot pressing process, attaching a thermosensitive adhesive film onto a male mould surface of the carbon fiber plate corresponding to a junction between a fastening portion of the housing and the planar portion; forming the fastening portion of the housing from thermosetting resin via embedded injection molding process; and during the embedded injection molding process, curing the thermosensitive adhesive film onto the surface of the carbon fiber plate by curing the thermosetting resin so as to join the fastening portion and the planar portion of the housing together. A housing of the electronic apparatus made by the manufacturing method is also described.

This application claims priority to Chinese patent application No. 2015I0574268.0 filed Sep. 10, 2015, the entire contents of which are incorporated herein by reference.

The present disclosure relates to a housing of an electronic apparatus, and particularly to a method for manufacturing the housing of the electronic apparatus. For example, the electronic apparatus is a laptop computer.

### BACKGROUND

For manufacturing a carbon fiber housing of the laptop computer, the carbon fiber material is prepared by hot pressing process.

### SUMMARY

For the manufacturing of a carbon fiber housing of the laptop, the technical solution of the present disclosure is to attach the thermosensitive adhesive film directly onto a male mould surface of the carbon fiber plate during the hot pressing process for a carbon fiber plate. Due to the fact that the hot pressing temperature for the carbon fiber plate is lower than the activation temperature of the thermosensitive adhesive film, the adhesive film remains unchanged during the hot pressing process. The adhesive film is cured onto the surface of the carbon fiber plate through the curing process of the thermosetting resin.

Specifically, one aspect according to the present disclosure proposes a method for manufacturing the housing of the electronic apparatus, the manufacturing method comprises:

Forming a planar portion of the housing as a carbon fiber plate from carbon fiber material via hot pressing process;

During the hot pressing process, attaching the thermosensitive adhesive film onto the male mould surface of the carbon fiber plate corresponding to a junction between a fastening portion of the housing and the planar portion;

Forming the fastening portion of the housing from thermosetting resin via embedded injection molding process;

During the embedded injection molding process, curing the thermosensitive adhesive film onto the surface of the carbon fiber plate by curing the thermosetting resin so as to join the fastening portion and the planar portion of the housing together.

The hot pressing temperature for the carbon fiber plate is lower than the activation temperature of the thermosensitive adhesive film, and the melting temperature of the thermosetting resin is higher than or equal to the activation temperature of the thermosensitive adhesive film.

The thermosensitive adhesive film remains unchanged during the hot pressing process.

The electronic apparatus is a laptop computer.

The fastening portion is a snap or a stud.

In view of the method of above present disclosure, another aspect according to the present disclosure provides a housing of the electronic apparatus, the housing comprising: a planar portion and a fastening portion, wherein the planar portion is a carbon fiber plate which is formed from carbon fiber materials via hot pressing process; a thermosensitive adhesive film provided onto the male mould surface of the carbon fiber plate corresponding to a junction between the fastening portion of the housing and the planar portion of the housing; the fastening portion of the housing is formed from thermosetting resin via embedded injection molding process; during the embedded injection molding process, curing the thermosensitive adhesive film onto the surface of the carbon fiber plate by curing the thermosetting resin so as to join the fastening portion and the planar portion of the housing together.

The hot pressing temperature for the carbon fiber plate is lower than the activation temperature of the thermosensitive adhesive film, and the melting temperature of the thermosetting resin is higher than or equal to the activation temperature of the thermosensitive adhesive film.

The thermosensitive adhesive film remains unchanged during the hot pressing process.

The electronic apparatus is a laptop computer.

The fastening portion is a snap or a stud.

The solution mentioned above is advantageous in that:

There is no production time restriction upon the provision of the thermosensitive adhesive film, the manufacturing and molding of the plate are completely separated from each other.

Due to the absence of dispensing process, adhesive residue will not occur around parts/components, while the surface of the parts/components having no contact with the resin remains unchanged, being unlikely to influence the appearance of the male mould surface. Through molding, the housing has less variation in its dimensions, thereby improving uniformity of the products. Due to the absence of dispensing process, it is possible to reduce the number of processes and manufacturing cost.

So far, in order that the detailed description of the present disclosure can be better understood, and also in order that the contribution of the present disclosure to the prior art can be best recognized, the present disclosure has summarized the embodiments of present disclosure quite extensively. Of course, the embodiments of the present disclosure will be described in the following, and will establish the subject matter of the attached claims.

Before explaining the embodiment of present disclosure in detail, it should be understood that the present disclosure is not restricted to the details of structure and configuration of the components set out in the following description or illustrated in the drawings. The present disclosure can comprise embodiments other than the described ones, and can be embodied and carried out in different manners. Moreover, it should be appreciated that the wording and terminology and summary used herein are merely for descriptive purpose, and should not be construed as being restrictive.

Likewise, the skilled person in this art would recognized that the technical conception on which the present disclosure is based may be readily used for the basis for designing other configuration and systems, and be used to implement several purposes of the present disclosure. Hence, it is important that the attached claims should be considered as encompassing such equivalent structures, so long as they do not go beyond the essence and scope of the present disclosure.

### BRIEF DESCRIPTION OF THE DRAWINGS

All of the technical features of the present disclosure would be obvious upon reviewing the drawings attached herein. The drawings described herein are merely used for the purpose of describing the selected embodiments, rather than all of the possible embodiments, and do not intend to limit the scope of the present disclosure.

FIG. 1 shows an overlapping arrangement in which gumming is performed at a junction of the plastic-carbon fiber plate;

FIG. 2 shows a carbon fiber plate provided with a thermosensitive adhesive film according to the present disclosure;

FIG. 3 shows a method for manufacturing a housing of an electronic apparatus according to the present disclosure.

### DETAILED DESCRIPTION

In the following, a detailed description will be made to the exemplary embodiments according to the present disclosure in accompany with the attached drawings. Based on the drawings and corresponding description, the skilled person in this art would comprehend the features and advantages of the present disclosure.

Generally, in the production process, a carbon fiber housing for a laptop computer only can be formed into a plane or a curved surface with a continuous large angle R because its relatively simple appearance structure. This causes a certain restriction upon its appearance design. Furthermore, such technology cannot be used to produce a fastening structure such as a snap or a stud and the like; further resulting in difficulties for the actual assembly.

To address the above problems, the embedded molding method is commonly employed for the process of the plastic/carbon fiber plate. The primary concept of such a process is to mold a planar portion of the parts/components with carbon fiber, and a fastening portion is molded by using plastic material by means of embedded injection molding process.

The key challenge for the above process is the magnitude of the adhesive force between the plastic-carbon fiber plates. If the adhesive force is too low, the parts would be subjected to breakage in its production or in its use, thus causing serious quality problems.

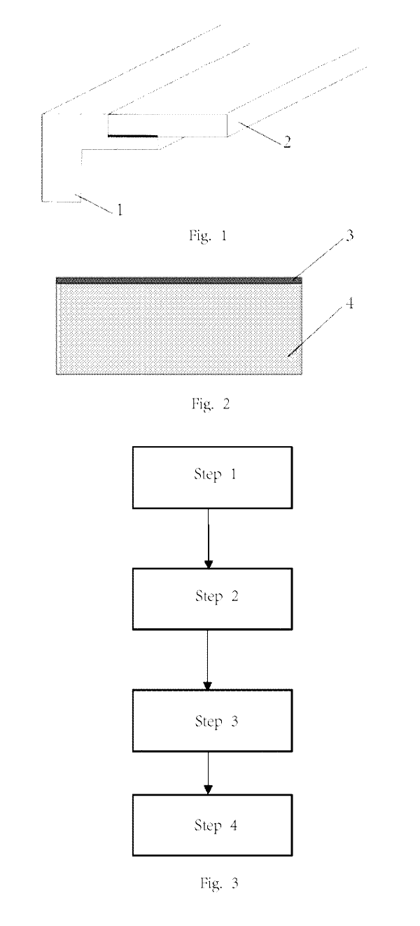

In FIG. 1, gumming is performed at a junction between a plastic I and a carbon fiber plate 2. Alternate to such gumming arrangement, the present disclosure primarily aims to attach a thermosensitive adhesive film directly onto a male mould surface of the carbon fiber plate during the hot pressing phase of the carbon fiber plate.

According to a first embodiment of the present disclosure, a method for manufacturing the housing of the electronic apparatus is proposed, wherein the manufacturing method comprises the following steps (as shown in FIG. 3): Step 1: forming a planar portion (such as the reference sign 2 in FIG. 1) of the housing as a carbon fiber plate from carbon fiber material via hot pressing process;

Step 2: during the hot pressing process, attaching the thermosensitive adhesive film 3 (see FIG. 2) onto the male mould surface of the carbon fiber plate 4 corresponding to the junction between the fastening portion of the housing (such as the reference sign 1 in FIG. 1) and the planar portion of the housing;

Step 3: forming the fastening portion of the housing from thermosetting resin via embedded injection molding process; Step 4: during the embedded injection molding process, curing the thermosensitive adhesive film onto the surface of the carbon fiber plate by curing the thermosetting resin so as to join the fastening portion and the planar portion of the housing together. During the molding process, the carbon fiber plate 4 attached with the thermosensitive adhesive film 3 is directly subjected to the embedded injection molding after it is provided into the mold. When the thermosetting resin with high fluidity contacts with the surface of the carbon fiber plate 4, the thermosetting resin would produce strong adhesion after curing because the temperature of the thermosetting resin is higher and reaches the activation temperature of the thermosensitive adhesive film, and thus the activated thermosensitive adhesive film will cause strong cohesiveness.

The hot pressing temperature for the carbon fiber plate is lower than the activation temperature of the thermosensitive adhesive film, and the melting temperature of the thermosetting resin is higher than or equal to the activation temperature of the thermosensitive adhesive film.

The thermosensitive adhesive film remains unchanged during the hot pressing process.

The electronic apparatus is a laptop computer.

The fastening portion is a snap or a stud.

In view of the above method of the present disclosure, another embodiment according to the present disclosure provides a housing of an electronic apparatus, the housing comprising: a planar portion (such as the reference sign 2 in FIG. 1) and a fastening portion (such as the reference sign 1 in FIG. 1), wherein the planar portion is a carbon fiber plate which is formed from carbon fiber materials via hot pressing process; a thermosensitive adhesive film 3 provided onto a male mould surface of a carbon fiber plate 4 corresponding to a junction between the fastening portion of the housing and the planar portion of the housing; the fastening portion of the housing is formed from thermosetting resin via embedded injection molding process; during the embedded injection molding process, curing the thermosensitive adhesive film onto the surface of the carbon fiber plate by curing the thermosetting resin so as to join the fastening portion and the planar portion of the housing together.

The hot pressing temperature for the carbon fiber plate is lower than the activation temperature of the thermosensitive adhesive film, and the melting temperature of the thermosetting resin is higher than or equal to the activation temperature of the thermosensitive adhesive film.

The thermosensitive adhesive film remains unchanged during the hot pressing process.

The electronic apparatus is a laptop computer.

The fastening portion is a snap or a stud.

The solution mentioned above is advantageous in that:

There is no production time restriction upon the provision of the thermosensitive adhesive film, the manufacturing and molding of the plate are completely separated from each other. Due to the absence of dispensing process, adhesive residue will not occur around the parts/components, while the surface of the parts/components having no contact with the resin remains unchanged, being unlikely to influence the appearance of the male mould surface.

Through molding, the housing has less variation in its dimensions, thereby improving uniformity of the products. Due to the absence of dispensing process, it is possible to reduce the number of processes and the manufacturing cost too. Furthermore, according to the solution of the present disclosure, it is possible to improve the adhesive force between the plastic-carbon fiber plates, thus substantially reducing the probability that the parts is broken and thus causes quality accidents.

Referring to the specific embodiments, although the present disclosure has already been described in the description and the drawings, it should be appreciated that the skilled person in this art could make various alteration and various equivalent matter could substitute for various elements therein without departing from the scope of the present disclosure defined by the attached claims. Furthermore, the combination and mating among the technical features, elements and/or functions of the specific embodiments herein is clear, thus according to the present disclosure, the skilled person in this art could appreciate that the technical features, elements and/or functions in these embodiments may be combined into another specific embodiment as required, unless the aforesaid contents being otherwise described. Moreover, according to the teaching of the present disclosure, much modification may be made so as to adapt to special situation or materials without departing from the essential scope of the present disclosure. Therefore, the present disclosures not limited to individual specific embodiments illustrated in the drawings, and specific embodiments described as the optimal embodiments proposed for conducting the present disclosure in the Description, but the present disclosure intends to encompass all the embodiments fall into the scope of the Description and the attached claims.

1. A method for manufacturing a housing of an electronic apparatus comprising:
forming a planar portion of the housing as a carbon fiber plate from carbon fiber material via a hot pressing process;
during the hot pressing process, attaching a thermosensitive adhesive film onto a male mould surface of the carbon fiber plate corresponding to a junction between a fastening portion of the housing and the planar portion;
forming the fastening portion of the housing from thermosetting resin via an embedded injection molding process;
during the embedded injection molding process, curing the thermosensitive adhesive film onto the surface of the carbon fiber plate by curing the thermosetting resin so as to join the fastening portion and the planar portion of the housing together.

2. The manufacturing method according to claim 1, wherein the hot pressing temperature for the carbon fiber plate is lower than the activation temperature of the thermosensitive adhesive film and the melting temperature of the thermosetting resin is higher than or equal to the activation temperature of the thermosensitive adhesive film.

3. The manufacturing method according to claim 2, wherein the thermosensitive adhesive film remains unchanged during the hot pressing process.

4. The manufacturing method according to claim 1, wherein the electronic apparatus is a laptop computer.

5. The manufacturing method according to claim 1, wherein the fastening portion is a snap or a stud.

6. A housing of an electronic apparatus, the housing comprising:
a planar portion and a fastening portion, wherein the planar portion is a carbon fiber plate that is formed from carbon fiber material via a hot pressing process;
a thermosensitive adhesive film provided onto a male mould surface of the carbon fiber plate corresponding to a junction between the fastening portion of the housing and the planar portion of the housing;
the fastening portion of the housing is formed from thermosetting resin via an embedded injection molding process;
during the embedded injection molding process, curing the thermosensitive adhesive film onto the surface of the carbon fiber plate by curing the thermosetting resin so as to join the fastening portion and the planar portion of the housing together.

7. The housing according to claim 6, wherein the hot pressing temperature for the carbon fiber plate is lower than the activation temperature of the thermosensitive adhesive film, and the melting temperature of the thermosetting resin is higher than or equal to the activation temperature of the thermosensitive adhesive film.

8. The housing according to claim 7, wherein the thermosensitive adhesive film remains unchanged during the hot pressing process.

9. The housing according to claim 6, wherein the electronic apparatus is a laptop computer.

10. The housing according to claim 6, wherein the fastening portion is a snap or a stud.
